(19) United States
(12) Patent Application Publication
(10) Pub. No.: US 2020/0255130 A1
(43) Pub. Date: Aug. 13, 2020

(54) Aircraft Wheel Spinning Assembly

(71) Applicant: Ali Javadzadeh, Irvine, CA (US)

(72) Inventor: Ali Javadzadeh, Irvine, CA (US)

(21) Appl. No.: 16/274,737

(22) Filed: Feb. 13, 2019

(51) Int. Cl. B64C 25/40

(52) U.S. Cl. CPC B64C 25/40; F03D 9/32

(57) ABSTRACT

An aircraft wheel spinning assembly includes a turbine that is movably mounted on an aircraft wheel. The turbine is positionable in a deployed position having the turbine being exposed with respect to the aircraft wheel. In this way the turbine is exposed to wind and the turbine generates rotational torque and subsequently rotates the aircraft wheel when the turbine is exposed to wind. Thus, the turbine reduces friction between a tire mounted on the aircraft wheel and a runway when the aircraft upon which the aircraft tire is mounted is landing on the runway. A hub is coupled to the aircraft wheel and a plurality of actuators is each coupled between the hub and the turbine. Each of the actuators is turned on to urge the turbine into the deployed position and each of the actuators is turned off to retract the turbine into the aircraft wheel.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to wheel spinning devices and more particularly pertains to a new wheel spinning device for spinning an aircraft wheel prior to touching down for landing.

### BRIEF SUMMARY OF THE INVENTION

An embodiment of the disclosure meets the needs presented above by generally comprising a turbine that is movably mounted on an aircraft wheel. The turbine is positionable in a deployed position having the turbine being exposed with respect to the aircraft wheel. In this way the turbine is exposed to wind and the turbine generates rotational torque and subsequently rotates the aircraft wheel when the turbine is exposed to wind. Thus, the turbine reduces friction between a tire mounted on the aircraft wheel and a runway when the aircraft upon which the aircraft tire is mounted is landing on the runway. A hub is coupled to the aircraft wheel and a plurality of actuators is each coupled between the hub and the turbine. Each of the actuators is turned on to urge the turbine into the deployed position and each of the actuators is turned off to retract the turbine into the aircraft wheel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a aircraft wheel spinning assembly according to an embodiment of the disclosure.

FIG. 2 is a back perspective view of an embodiment of the disclosure.

FIG. 3 is a perspective in-use view of an embodiment of the disclosure showing a turbine in a deployed position on an aircraft wheel.

FIG. 4 is a right side in-use view of an embodiment of the disclosure.

FIG. 5 is a cross sectional view taken along line 5-5 of FIG. 4 of an embodiment of the disclosure.

FIG. 6 is a detail view taken from circle 6 of FIG. 5 of an embodiment of the disclosure.

### DETAILED DESCRIPTION OF THE INVENTION

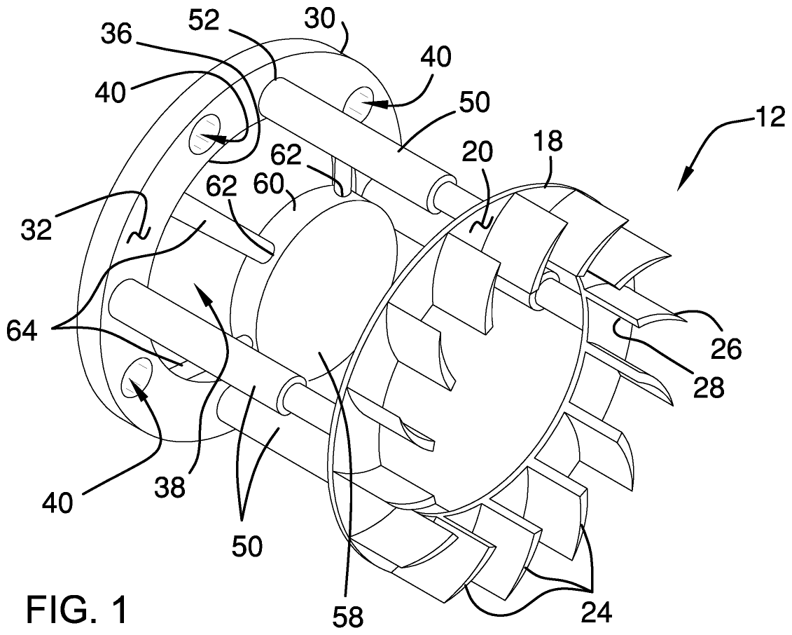

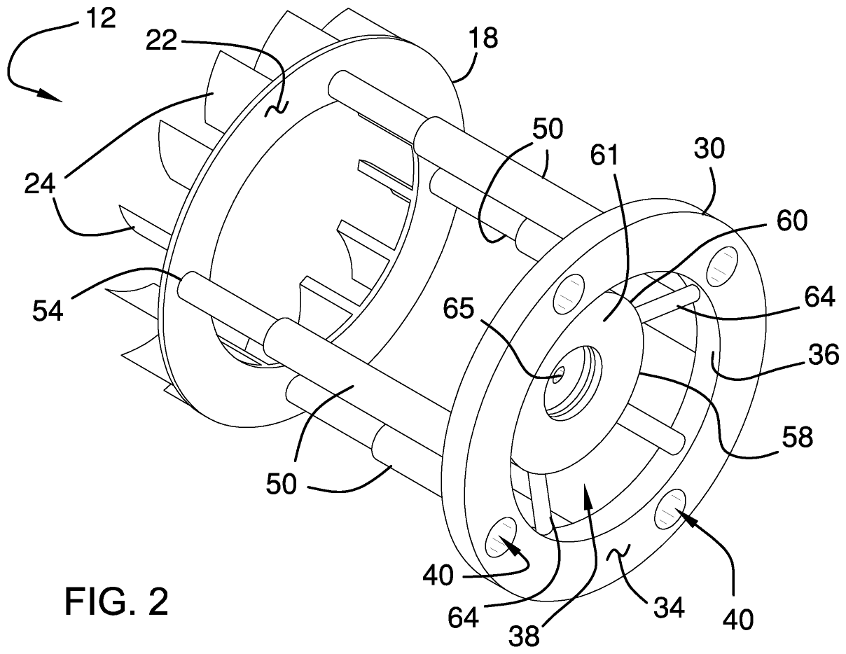

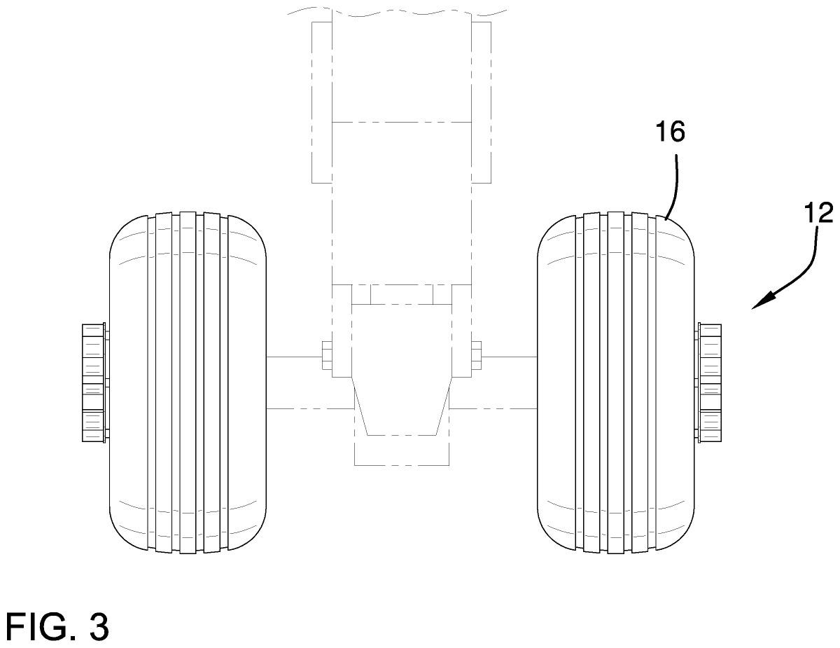

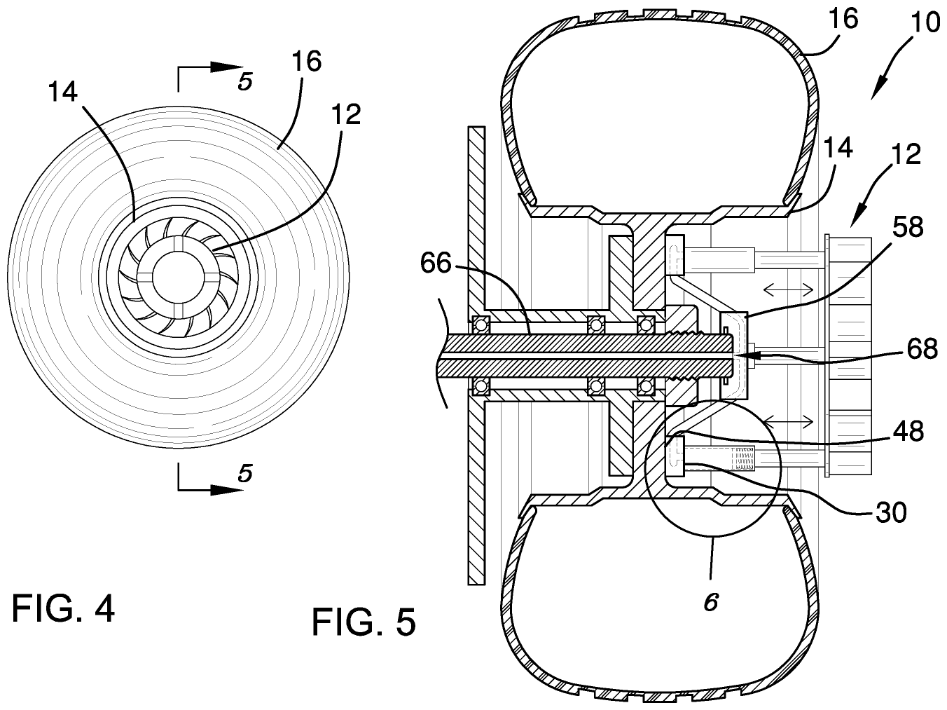

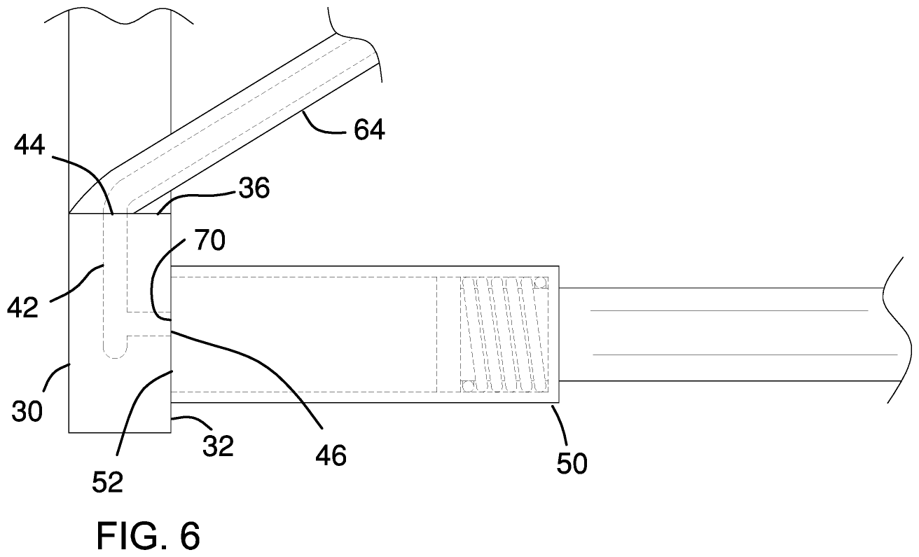

With reference now to the drawings, and in particular to FIGS. 1 through 6 thereof, a new wheel spinning device embodying the principles and concepts of an embodiment of the disclosure and generally designated by the reference numeral 10 will be described.

As best illustrated in FIGS. 1 through 6, the aircraft wheel spinning assembly 10 generally comprises a turbine 12 that is movably mounted on an aircraft wheel 14. The aircraft wheel 14 may be an aircraft wheel such as is employed on commercial airliners or the like. The turbine 12 is positionable in a deployed position having the turbine 12 being exposed with respect to the aircraft wheel 14. In this way the turbine 12 is exposed to wind when the landing gear on which the aircraft wheel 14 is mounted is deployed for landing. Thus, the turbine 12 generates rotational torque and subsequently rotates the aircraft wheel 14 when the turbine 12 is exposed to wind. In this way the aircraft wheel 14 is spun in a forward direction before the aircraft wheel 14 makes contact with a runway. Moreover, the turbine 12 reduces friction between a tire 16 mounted on the aircraft wheel 14 and the runway when the aircraft lands.

The turbine 12 comprises a ring 18 that has a first surface 20 and a second surface 22. A plurality of vanes 24 is each coupled to and extends away from the first surface 20 of the ring 18. The vanes 24 are spaced apart from each other and are distributed around the ring 18. Moreover, each of the vanes 24 has a front edge 26 and a back edge 28, and each of the vanes 24 is concavely arcuate between the front 26 and back 28 edges. Thus, each of the vanes 24 captures air when the turbine 12 is positioned in the deployed position. Additionally, each of the first 20 and second 22 surfaces of the ring 18 is rotated in a first direction about a longitudinal axis extending through a center of the ring 18 when the vanes 24 capture air. The first direction corresponds to forward rotation of the aircraft wheel 14.

A hub 30 is provided and the hub 30 is coupled to the aircraft wheel 14. The hub 30 has a front surface 32, a back surface 34 and a perimeter edge 36 extending therebetween. The perimeter edge 36 is continuously arcuate about a central axis extending through the front 32 and back 34 surfaces to define an opening 38 extending through the hub 30. The hub 30 has a plurality of mounting apertures 40 each extending through the front 32 and back 34 surfaces. The mounting apertures 40 are spaced apart from each other and are distributed around the hub 30.

The hub 30 has a plurality of conduits 42 each being integrated therein, and each of the conduits 42 extends through the perimeter edge 36 and the front surface 32. Each of the conduits 42 has a first opening 44 and a second opening 46. The perimeter edge 36 has the first opening 44 of each of the conduits 42 being associated therewith and the front surface 32 has the second opening 46 of each of the conduits 42 being associated therewith. The back surface 34 of the hub 30 abuts an outboard face 48 of the aircraft wheel 14. Additionally, a plurality of fasteners, such as bolts or the like, each extends through a respective one of the mounting apertures 40 and engages the aircraft wheel 14 for retaining the hub 30 on the aircraft wheel 14.

A plurality of actuators 50 is each of the actuators 50 is coupled between the hub 30 and the turbine 12. Each of the actuators 50 is turned on to urge the turbine 12 into the deployed position. Additionally, each of the actuators 50 is turned off to retract the turbine 12 into the aircraft wheel 14. Each of the actuators 50 has a first end 52 and a second end 54, and each of the actuators 50 elongates between the first 52 and second 54 end when the actuators 50 are turned on. Moreover, each of the actuators 50 shortens between the first 52 and second 54 ends when the actuators 50 are turned off. Each of the actuators 50 is in operational communication with a power source 56 comprising an electrical system of the aircraft.

The first end 52 of each of the actuators 50 is coupled to the front surface 32 of the hub 30. Additionally, the first end 52 of each of the actuators 50 is aligned with the second opening 46 of a respective one of the conduits 42. The second end 54 of each of the actuators 50 is coupled to the second surface 22 of the ring 18. Each of the vanes 24 is recessed with respect to an outboard flange of the aircraft wheel 14 when the actuators 50 are turned off. In this way each of the vanes 24 is hidden from wind. Each of the vanes 24 is exposed with respect to the outboard flange when the actuators 50 are turned on. In this way each of the vanes 24 is exposed to wind. Each of the actuators 50 may include a spring that biases the actuators 50 to shorten.

A fluid reservoir 58 may be provided that contains a hydraulic fluid. The fluid reservoir 58 may be positioned in the opening 38 in the hub 30. The fluid reservoir 58 may have an outer edge 60 and a rear face 61, and the outer edge 60 may have has a plurality of outlets 62 each extending into an interior of the fluid reservoir 58. A plurality of pipes 64 may each be fluidly coupled between a respective one of the outlets 62 and the first opening 44 on the perimeter edge 36 of the hub 30 of a respective one of the conduits 42. Thus, each of the conduits 42 may be in fluid communication with the fluid reservoir 58.

The rear face 61 of the fluid reservoir 58 may have a fluid coupling 65 extending therein, and an axle 66 upon which the aircraft wheel 14 is mounted may have a fluid conduit 68 extending therethrough. The fluid conduit 68 may be in fluid communication with a hydraulic system of the aircraft for supplying hydraulic pressure. The fluid conduit 68 may be in fluid communication with the fluid coupling 65 when the hub 30 is attached to the aircraft wheel 14. Thus, the fluid reservoir 58 may receive hydraulic pressure from the hydraulic system of the aircraft.

Each of the actuators 50 may comprise a hydraulic piston which has a fluid inlet 70. The fluid inlet 70 of each of the hydraulic pistons may be in fluid communication with the second opening 46 of a respective one of the conduits 42. In this way the fluid inlet 70 of each of the hydraulic pistons is in fluid communication with the fluid reservoir 58 for receiving the hydraulic fluid. Alternatively, each of the actuators 50 may be a pneumatic piston that is each in fluid communication with a source of compressed air. Each of the actuators 50 may additionally be an electro-mechanical linear actuator or the like.

In use, each of the actuators 50 is turned on when the landing gear of the aircraft is deployed. Thus, the vanes 24 are exposed to wind and subsequently cause the aircraft wheel 14 to begin rotating in the forward direction. Ultimately, the aircraft wheel 14 will accelerate to a rotational speed that matches the air speed of the aircraft. Thus, friction between the tire 16 on the aircraft wheel 14 and the runway is reduced upon touchdown. In this way vibration and unpleasant jarring is reduced for individuals flying in the aircraft when the aircraft touches down.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An aircraft wheel spinning assembly being configured to spin an aircraft wheel prior to landing thereby reducing tire friction upon landing, said assembly comprising:
a turbine being movably mounted on an aircraft wheel, said turbine being positionable in a deployed position having said turbine being exposed with respect to the aircraft wheel wherein said turbine is configured to be exposed to wind, said turbine generating rotational torque and subsequently rotating the aircraft wheel when said turbine is exposed to wind wherein said turbine is configured to reduce friction between a tire mounted on the aircraft wheel and a runway when the aircraft upon which the aircraft tire is mounted is landing on the runway;
a hub being coupled to the aircraft wheel; and
a plurality of actuators, each of said actuators being coupled between said hub and said turbine, each of said actuators being turned on to urge said turbine into said deployed position, each of said actuators being turned off to retract said turbine into the aircraft wheel.

2. The assembly according to claim 1, wherein said turbine comprises:
a ring having a first surface and a second surface; and
a plurality of vanes, each of said vanes being coupled to and extending away from said first surface of said ring, said vanes being spaced apart from each other and being distributed around said ring, each of said vanes having a front edge and a back edge, each of said vanes being concavely arcuate between said front and back edges wherein each of said vanes is configured to capture air when said turbine is positioned in said deployed position, each of said first and second surfaces of said ring being rotated in a first direction about a longitudinal axis extending through a center of said ring when said vanes capture air, said first direction corresponding to forward rotation of the aircraft wheel.

3. The assembly according to claim 1, wherein said hub has a front surface, a back surface and a perimeter edge extending therebetween, said perimeter edge being continuously arcuate about a central axis extending through said front and back surfaces to define an opening extending through said hub, said hub having a plurality of mounting apertures each extending through said front and back surfaces, said mounting apertures being spaced apart from each other and being distributed around said hub.

4. The assembly according to claim 3, wherein said hub has a plurality of conduits each being integrated therein, each of said conduits extending through said perimeter edge and said front surface, each of said conduits having a first opening and a second opening, said perimeter edge having said first opening of each of said conduits being associated therewith, said front surface having said second opening of each of said conduits being associated therewith.

5. The assembly according to claim 4, wherein said back surface of said hub abuts an outboard face of the aircraft wheel having a plurality of fasteners each extending through a respective one of said mounting apertures and engaging the aircraft wheel for retaining said hub on the aircraft wheel.

6. The assembly according to claim 4, wherein each of said actuators has a first end and a second end, each of said actuators elongating between said first and second end when said actuators are turned on, each of said actuators shortening between said first and second ends when said actuators are turned off, each of said actuators being in operational communication with a power source comprising an electrical system of the aircraft, said first end of each of said actuators being coupled to said front surface of said hub, said first end of each of said actuators being aligned with said second opening of a respective one of said conduits.

7. The assembly according to claim 6, wherein:
said turbine includes a ring, said ring having a first surface and a second surface; and
said second end of each of said actuators is coupled to said second surface of said ring, each of said vanes being recessed with respect to an outboard flange of the aircraft wheel when said actuators are turned off wherein each of said vanes is configured to be hidden from wind, each of said vanes being exposed with respect to the outboard flange when said actuators are turned on wherein each of said vanes is configured to be exposed to wind.

8. An aircraft wheel spinning assembly being configured to spin an aircraft wheel prior to landing thereby reducing tire friction upon landing, said assembly comprising:
a turbine being movably mounted on an aircraft wheel, said turbine being positionable in a deployed position having said turbine being exposed with respect to the aircraft wheel wherein said turbine is configured to be exposed to wind, said turbine generating rotational torque and subsequently rotating the aircraft wheel when said turbine is exposed to wind wherein said turbine is configured to reduce friction between a tire mounted on the aircraft wheel and a runway when the aircraft upon which the aircraft tire is mounted is landing on the runway, said turbine comprising:
a ring having a first surface and a second surface; and
a plurality of vanes, each of said vanes being coupled to and extending away from said first surface of said ring, said vanes being spaced apart from each other and being distributed around said ring, each of said vanes having a front edge and a back edge, each of said vanes being concavely arcuate between said front and back edges wherein each of said vanes is configured to capture air when said turbine is positioned in said deployed position, each of said first and second surfaces of said ring being rotated in a first direction about a longitudinal axis extending through a center of said ring when said vanes capture air, said first direction corresponding to forward rotation of the aircraft wheel;
a hub being coupled to the aircraft wheel, said hub having a front surface, a back surface and a perimeter edge extending therebetween, said perimeter edge being continuously arcuate about a central axis extending through said front and back surfaces to define an opening extending through said hub, said hub having a plurality of mounting apertures each extending through said front and back surfaces, said mounting apertures being spaced apart from each other and being distributed around said hub, said hub having a plurality of conduits each being integrated therein, each of said conduits extending through said perimeter edge and said front surface, each of said conduits having a first opening and a second opening, said perimeter edge having said first opening of each of said conduits being associated therewith, said front surface having said second opening of each of said conduits being associated therewith, said back surface of said hub abutting an outboard face of the aircraft wheel having a plurality of fasteners each extending through a respective one of said mounting apertures and engaging the aircraft wheel for retaining said hub on the aircraft wheel; and
a plurality of actuators, each of said actuators being coupled between said hub and said turbine, each of said actuators being turned on to urge said turbine into said deployed position, each of said actuators being turned off to retract said turbine into the aircraft wheel, each of said actuators having a first end and a second end, each of said actuators elongating between said first and second end when said actuators are turned on, each of said actuators shortening between said first and second ends when said actuators are turned off, each of said actuators being in operational communication with a power source comprising an electrical system of the aircraft, said first end of each of said actuators being coupled to said front surface of said hub, said first end of each of said actuators being aligned with said second opening of a respective one of said conduits, said second end of each of said actuators being coupled to said second surface of said ring, each of said vanes being recessed with respect to an outboard flange of the aircraft wheel when said actuators are turned off wherein each of said vanes is configured to be hidden from wind, each of said vanes being exposed with respect to the outboard flange when said actuators are turned on wherein each of said vanes is configured to be exposed to wind.

9. The assembly according to claim 8, further comprising a fluid reservoir containing a hydraulic fluid, said fluid reservoir being positioned in said opening in said hub, said fluid reservoir having an outer edge, said outer edge having a plurality of outlets each extending into an interior of said fluid reservoir.

10. The assembly according to claim 9, further comprising a plurality of pipes, each of said pipes being fluidly coupled between a respective one of said outlets and a said first opening on said perimeter edge of said hub of a respective one of said conduits, each of said conduits being in fluid communication with said fluid reservoir.

11. The assembly according to claim 10, wherein each of said actuators comprises a hydraulic piston having a fluid inlet, said fluid inlet of each of said hydraulic pistons being in fluid communication with said second opening of a respective one of said conduits such that said fluid inlet of each of said hydraulic pistons is in fluid communication with said fluid reservoir for receiving the hydraulic fluid.
